(19) United States
(12) Patent Application Publication
(10) Pub. No.: US 2008/0066622 A1
(43) Pub. Date: Mar. 20, 2008

(54) REFLECTING PACKED COLUMN

(76) Inventor: Dahui FANG, Xiangtan (CN)

Correspondence Address: MATTHIAS SCHOLL, 14781 MEMORIAL DRIVE, SUITE 1319, HOUSTON, TX, 77079, US

(21) Appl. No.: 11/946,746

(22) Filed: Nov. 28, 2007

Related U.S. Application Data
(63) Continuation of application No. PCT/CN2006/000915, filed on May 8, 2006.

(30) Foreign Application Priority Data
May 28, 2005 (CN) 200510031623.6

(51) Int. Cl. B01D 47/00

(52) U.S. Cl. 96/290

(57) ABSTRACT

This invention teaches a packed column, comprising an outer cylinder, a support plate, and a plurality of fluid balls, wherein an inner cylinder is connected to the center of the support plate, and a plurality of openings and deflectors connected to the openings are disposed on the circular edge of the inner cylinder. By setting a circular spin and planetary travel path for the fluid balls, a series of problems influencing the mass transfer speed are solved. This invention has the following characteristics: 1) the technical problems such that the gas and liquid contact area of static bed packing is small and the operation of turbulent bed is unstable are solved completely; 2) the spray liquid is utilized completely, the consumption of the spray liquid is reduced and the operation cost of the reflecting packed column is decreased; and there is no stringent requirement on the pressure and atomization degree to the spray liquid; 3) the mass transfer effect having a low resistance and high efficiency can be achieved without increasing the air pressure; 4) an absorption liquid circulation system with dual or more loops can be realized; the purpose of multilevel flow split and multistage liquid processing can be reached; and 5) the reflecting packed column has a simple structure and has fewer easily worn-out parts; the scaling buildup can be avoided resulting from the planetary motion of the fluid balls. The reflecting packed column of this invention is applicable to various mass transfer processes.

### CROSS-REFERENCE TO RELATED APPLICATIONS

This application is a continuation of International Patent Application No. PCT/CN2006/000915 with an international filing date of May 8, 2006, designating the United States, now pending, and further claims priority benefits to Chinese Patent Application No. 200510031623.6, filed on May 28, 2005. The contents of the aforementioned specifications are incorporated herein by reference

### BACKGROUND OF THE INVENTION

1. Field of the Invention

This invention relates to a mass transfer equipment capable of purifying gases and removing solid dust, being used for various mass transfer processes, and more particularly to a reflecting packed column.

2. Description of the Related Art

Protecting environment and saving energy are important endeavors for various countries in the world so as to sustain economic growth. In order to reduce product and investment cost, relevant enterprises are in an urgent need of highly efficient, energy saving, and low cost multiphase separation equipments. On the other hand, in chemical engineering processes, such as absorption, extraction, and drying, mass transfer equipment having high transfer speed and low energy consumption is also required in order to decrease production cost and equipment investment.

In order to meet the requirement of above industrial developments, the existing mass transfer equipments, such as bubble columns, plate columns, spray columns, jet columns are all improved largely. Usually, for these equipments, the interphase mass transfer effect is enhanced by increasing the interphase contact space so as to increase the interphase contact time, or by increasing the liquid flow rate so as to increase the interphase contact area. However, in this way, a huge column body is generally needed for the mass transfer equipment, resulting in a large produce area and high equipment investment.

In order to decrease the volume of column body, conventional technology also tries to increase the gas flow speed so as to increase the interphase mass transfer effect. However, this is difficult to realize due to the technical limit of these equipments themselves. For example, with the increase of gas flow speed, the resistance force increases sharply for plate column, and the energy consumption increases, the spray liquid drop for spray column increases, the interphase contact specific area decreases, and thus the desired highly efficient mass transfer cannot be realized. Then, the interphase mass transfer effect cannot be improved further.

It is well known that packed column has a higher mass transfer speed than bubble column, plate column, or spray column. However, it is difficult to implement methods and structures for conventional packed columns which would not only strengthen the mass transfer but also consume less energy. The reasons for this problem are, for most of the equipments, that the mass transfer phase or part of the mass transfer phase is continuous. For example, for spray column, the liquid phase is sprayed through a nozzle to form liquid drop and thus becomes dispersion phase, while the gas phase is continuous; for bubble column, the gas phase is introduced from the bottom of the liquid phase, and passes through the liquid phase in the form of bubble under the function of pressure, the gas phase is disperse while the liquid phase is continuous; for static bed packed column, the material is packed in the column body, the liquid phase flows downwards through the gaps of the packing material, while the gas phase flows upwards through the gaps of the packing material, the gas meets with the liquid in the gaps, and both the liquid phase and the gas phase are continuous.

Much efforts have been directed at finding a method to strengthen mass transfer so as to disperse each mass transfer phase to mix different phases completely, and thus to increase the interphase contact area. However, although some success has been achieved in increasing the mass transfer efficiency, there is still lack of technology to improve dispersion of the mass transfer phases.

For example, Chinese Pat. Appl. Publ. No. CN 2431943 Y discloses a volute inlet three-phase fluid bed for dust cleaning and desulfurizing, comprising a desulfurizing tower and a venturi tube, wherein the desulfurizing tower is disposed with a vortex plate demister plate, a cleaning and absorption liquid spray apparatus, a packing ball, a packing grating, and a spray type temperature reductioner from top to bottom orderly, and a grey water discharge outlet is opened at the lower portion of the desulfurizing tower. The venture tube is disposed between the spray temperature reductioner and the grey water discharge outlet, and is connected with the desulfurizing tower body. However, this structure is complicated, the adaptive range of the gas flow speed inside of the tower is limited, so that different gas flow rates required by most absorption processes cannot be guaranteed, and the electricity consumption with the addition of venture tube is relatively high.

In addition, U.S. Pat. No. 5,234,672 titled “Method and apparatus for increasing the separating capacity of a flue gas desulfurization apparatus” suggests to provide at least one baffle plate within an end section of the horizontal flue gas channel in the vicinity of the desulfurization reactor so as to cause turbulence in the flue gas to form turbulent flow before the flue gas enters the desulfurization reactor so as to increase the separation capability. However, the intensity of the turbulent flow decreases with the increase of the distance from the turbulent flow generator; and the gas phase is continuous.

### SUMMARY OF THE INVENTION

In accordance with this invention, by reflecting the packing materials, most phases can be dispersed in the reflecting packing mass transfer fields, the dispersed multiple phase units strike to each other so that the purpose of refining the units and thus to increase largely the interphase contact specific areas can be realized, and thus the unit surface can be refreshed quickly and the stable high speed mass transfer in the multiple phases are obtained. The further purpose of this invention is to keep the same solute of various substances away from balance in the chemical reactions in the reflecting packing mass transfer field so as to keep the mass transfer in high speed and thus to increase the separation and response efficiency of the equipment largely.

Therefore, it is one objective of this invention to provide a reflecting packed column with the features of simple structure and high mass transfer efficiency, as well as low water usage, low electricity consumption, easy maintenance, and wide gas flow adaptive range.

In order to realize the above objective, provided is a reflecting packed column, comprising an outer cylinder, a support plate set inside of the outer cylinder, a plurality of fluid balls disposed on the outer cylinder, and an absorption liquid spray tube, wherein a gas flow inlet, an gas flow outlet, and an absorption liquid discharge outlet are disposed out of the outer cylinder, the support plate is engaged with the inner wall of the outer cylinder, an inner cylinder is connected to the center of the support plate, and a plurality of openings and deflectors connected to the openings are disposed on the circular edge of the inner cylinder.

To realize better mass transfer effect, in further embodiments of this invention, the inclination angle of the deflector is a sharp angle.

In further embodiments of this invention, the opening is a strip type opening.

In further embodiments of this invention, the opening is irregular.

In further embodiments of this invention, the openings are circular array arranged.

In further embodiments of this invention, the fluid balls are planetarily arranged on the support plate at a position between the inner cylinder and the outer cylinder.

In further embodiments of this invention, the absorption liquid spray tube is disposed along the circular edge of the inner cylinder on the support plate.

In further embodiments of this invention, the support plate, the fluid balls disposed on the support plate, and the absorption liquid spray tubes form a one-layer structure.

In further embodiments of this invention, the support plate, the fluid balls disposed on the support plate, and the absorption liquid spray tubes form a two-layer structure.

In further embodiments of this invention, the support plate, the fluid balls disposed on the support plate, and the absorption liquid spray tubes form a multi-layer structure.

In further embodiments of this invention, a liquid catch tray is disposed between the two layers of the two-layer structure, and the liquid catch tray is a frustum cone having a central through hole.

In further embodiments of this invention, the absorption liquid discharge outlet is disposed at the lower portion of the liquid catch tray.

In further embodiments of this invention, the absorption liquid discharge outlet is disposed at the lower portion of the outer cylinder.

In further embodiments of this invention, the gas flow inlet on the outer cylinder is disposed on the upper portion or on the lower portion.

Therefore, by setting openings and deflectors on the support plate, and combining the outer cylinder and thus the inner cylinder and the circular spray arrangement so as to form an circular planet travel path for the fluid balls, a series of problems influencing the mass transfer speed in existing technical solutions are solved.

This invention provides the following characteristics:

(1) the sharp angle strip deflectors opened along the circular edge of the support plate make the gas flow upwards along the radial direction so as to push the fluid balls to move circularly. Through the spin and planetary motion of the fluid balls, the specific areas of the gas and liquid phases in the mass transfer field is increased largely, thus the technical problems such that the gas and liquid contact area of static bed packing is small and the operation of turbulent bed is unstable are solved completely;

(2) the diameter of the fluid ball in the reflecting packed column is in the range of 20-50 mm, the height of grade one fluid bed is in the range of 100-250 mm, the liquid phase and the gas phase keep the mass transfer in high speed under the function of the continuous spin and planetary motion of the fluid balls, the spray liquid is utilized completely, so that there is no stringent requirement on the pressure and atomization degree of the spray liquid. Thus, the consumption of the spray liquid is reduced, and the operation cost of the reflecting packed column is decreased;

(3) the resistance to gas flow for the one-layer mass transfer field of reflecting packed column is about 200-400 Pa, and will be increased to 600-800 Pa for a two-layer mass transfer field, so that the mass transfer effect having a low resistance and high efficiency can be achieved without increasing the gas pressure;

(4) the reflecting packed column can be set with a fluid mass transfer fields having a one-layer structure, a two-layer structure, or a multi-layer structure; at the same time, an absorption liquid circulation system with dual or more loops can be realized, so that the purpose of multilevel flow split and multistage liquid processing can be reached; and

(5) the reflecting packed column has a simple structure, is easy to produce and maintain, has parts that are less easy to wear-out, and in which the scaling buildup can be avoided resulting from the planetary motion of the fluid balls;

In embodiments of this invention, the dust purification efficiency can reach 99.9%, while the water and electricity consumptions are relatively low; when it is applied to chemical engineering, most mass transfer processes can be realized. Therefore, the reflecting packed column of this invention can be used widely.

This invention will hereinafter be described further according to the embodiments and appended drawings.

### BRIEF DESCRIPTION OF THE DRAWINGS

FIG. 1 illustrates a reflecting packed column with a gas flow inlet located at the lower portion according to one embodiment of this invention;

FIG. 2 illustrates a reflecting packed column with a gas flow inlet located at the upper portion according to one embodiment of this invention;

FIG. 3 illustrates a one-layer structure of a support plate, a plurality of fluid balls, and an absorption liquid spray tube according to one embodiment of this invention;

FIG. 4 is a top view of the embodiment of FIG. 1;

FIG. 5 is a top view of the embodiment of FIG. 2;

FIG. 6 is a structural view of a support plate according to one embodiment of this invention;

FIG. 7 is a cross sectional view along the A-A line in FIG. 6;

FIG. 8 is a structural view of an absorption liquid spray tube according to one embodiment of this invention;

FIG. 9 is a structural view of a liquid catch tray according to one embodiment of this invention; and

FIG. 10 is a structural view of a demister plate according to one embodiment of this invention.

### DETAILED DESCRIPTION OF THE INVENTION

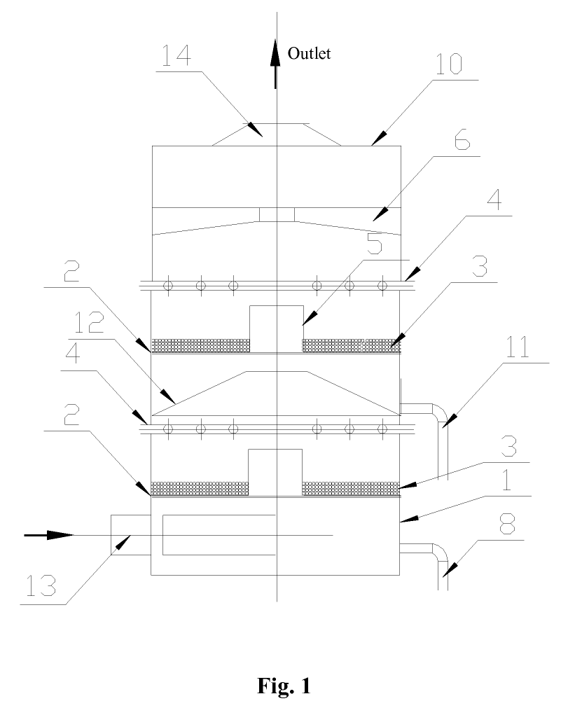

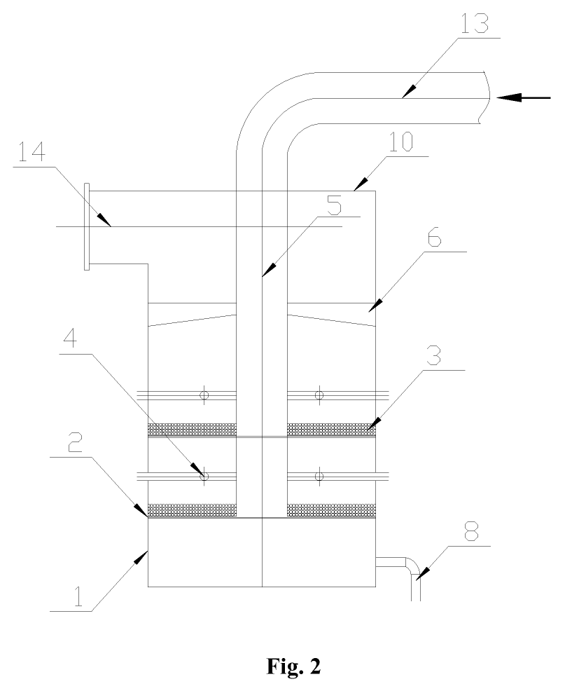

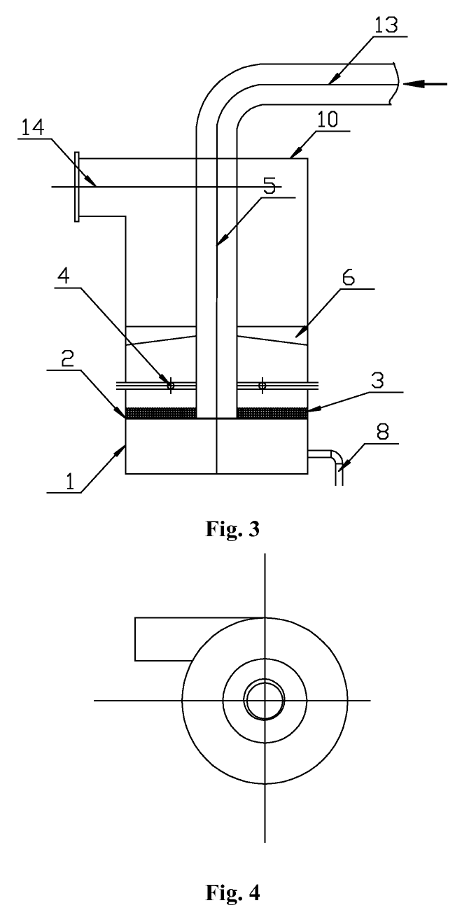

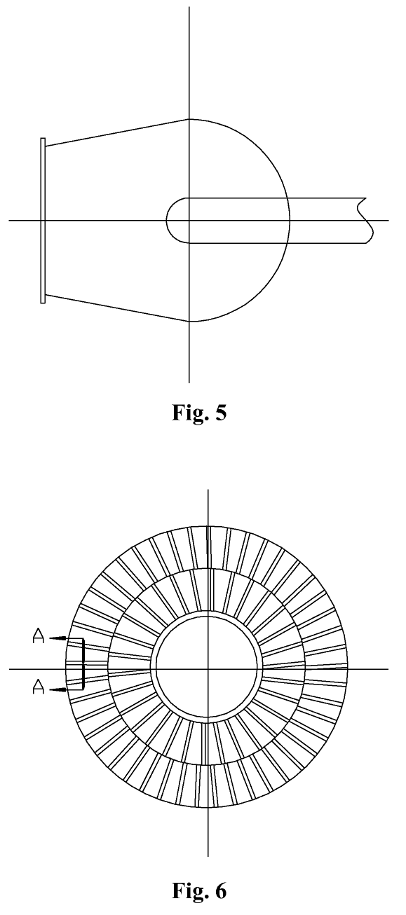

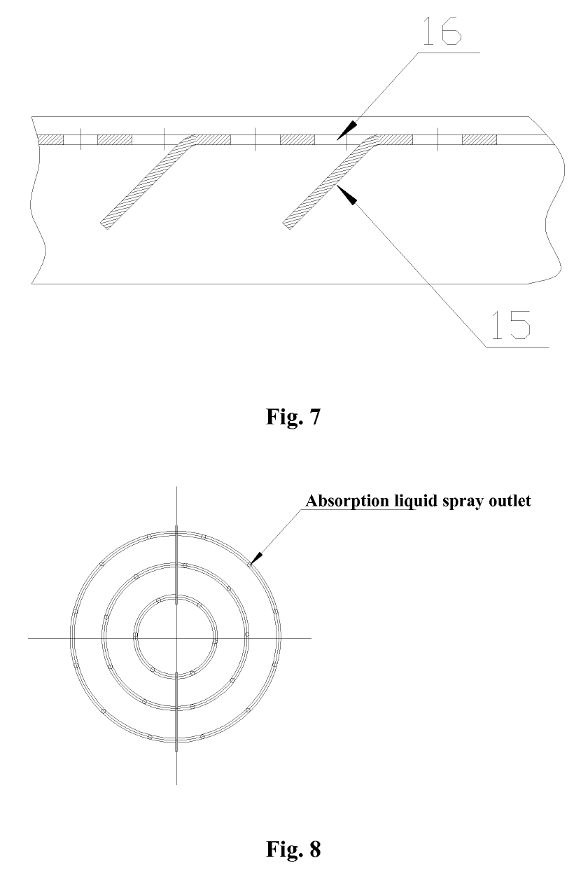

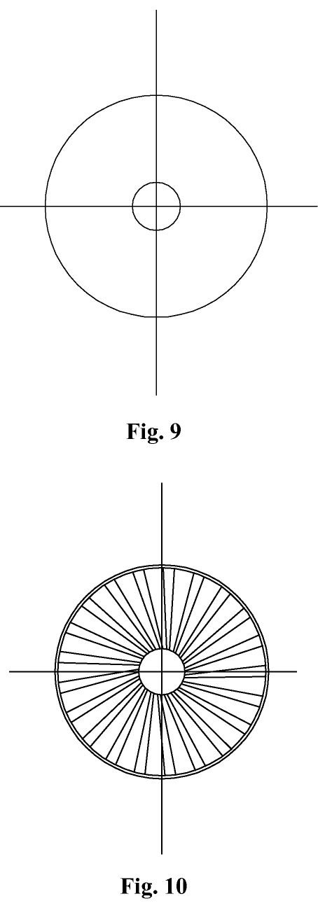

As shown in FIGS. 1-10, a reflecting packed column comprises an outer cylinder 1, a support plate 2 located inside of the outer cylinder 1, a plurality of fluid balls 3 set on the support plate 2, and an absorption liquid spray tube 4, wherein an inner cylinder 5 is connected to the center of the support plate 2 and a plurality of openings 16 and a plurality of deflectors 15 connected to the openings are disposed on the circular edge of the inner cylinder 5.

A central through hole for housing the inner cylinder 5 is disposed on the support plate 2. When the external gas flow inlet 13 is disposed at the lower portion of the outer cylinder 1, the inner cylinder 5 is dead-ended, as shown in FIG. 1. A plurality of openings 16 and a plurality of deflectors 15 connected to the openings are also set along the circular edge of the central through hole of the support plate 2. The deflector 15 and the support plate 2 cross. Optimally, the inclination angle of the deflector 15 is a sharp angle. In the present embodiment, the inclination angle is 45°.

The openings 16 on the support plate 2 are circularly arranged, wherein the opening can be in a shape of a strip or other irregular shapes. In this embodiment of the invention, the opening is in a shape of strip in order to simplify the manufacturing process. The inner cylinder 5 and the outer cylinder 1 are concentric. The inner cylinder 5 is installed on the central through hole of the support plate 2 and is fixed at the lower portion of the outer cylinder 1 through the support plate 2. A plurality of fluid balls 3 and an absorption liquid spray tube 4 are disposed on the circular path of the support plate 2 between the inner cylinder 5 and the outer cylinder 1. A demister plate 6, a gas flow outlet 14, and a seal cover 10 are disposed on the circular path. An absorption liquid discharge outlet 8 is disposed between the support plate 2 and the bottom of the outer cylinder 1, while the absorption liquid discharge outlet 11 is disposed at the lower portion of the liquid catch tray 12.

In order to increase the mass transfer efficiency, the support plate 2, the fluid balls 3 located thereon, and the absorption liquid spray tube 4 are designed to form a multi-layer structure according to demand. In this embodiment of the invention, they are designed to form a one-layer structure and a two-layer structure.

In a two-layer structure, a liquid catch tray 12 is disposed between the two layers. The liquid catch tray 12 is a frustum cone having a central through hole. An absorption liquid discharge outlet 11 is disposed at the lower portion of the liquid catch tray 12. The absorption liquid spray tube 4 can be distributed uniformly according to the distance between the inner cylinder 5 and the outer cylinder 1. In order to keep the consistency of the pressure in the absorption liquid spray tube 4, the absorption liquid spray tube 4 is disposed with two symmetrically arranged inlets.

When the gas flow inlet 13 is disposed at the lower portion of the outer cylinder 1, the inner cylinder 5 is dead ended. Gases flow from the bottom of the outer cylinder 1 into the fluid balls 3 inside of the support plate circular travel path through the openings 16 and the deflectors 15 of the support plate 2. Guided by the deflectors 15, the gas flows upwards along the radial direction at a sharp angle so as to push the fluid balls to spin and planetarily move along the circular path between the inner cylinder 5 and the outer cylinder 1. Under the lubrication of the spray liquid from the absorption liquid spray tube 4, a layer of liquid film is formed on the surface of the fluid balls 3 and acts as an absorption layer.

In a one-layer structure, the absorption spray liquid after being processed flows to the bottom of the outer cylinder 1 and is discharged through the absorption liquid discharge outlet 8, while the purified gases are discharged through the gas flow outlet 14 after being dehydrated by the demister plate 6. In a two-layer structure, after being processed by the first layer, the absorption liquid spray flows to the bottom of the outer cylinder and is discharged through the absorption liquid discharge outlet 8, while the purified gases flow into the support plate 2 of the second layer via the central through hole of the liquid catch tray 12, and then flow into the fluid balls 3 inside of the support plate circular path via the openings 16 and the deflectors 15 on the support plate. Guided by the deflectors 15, the gas flows upwards along the radial direction in sharp angle so as to push the fluid balls to spin and planetary move along the circular path between the inner cylinder 5 and the outer cylinder 1. Under the lubrication of the spray liquid from the absorption liquid spray tube 4, a layer of liquid film is formed on the surface of the fluid balls 3 and acts as an absorption layer. After being processed by the second layer, the absorption spray liquid flows onto the surface of the frustum cone of the liquid catch tray 12 and then is discharged through the absorption liquid discharge outlet 11, while the purified gases are discharged through the gas flow outlet 14 after being dehydrated by the demister plate 6.

When the gas flow inlet 13 is disposed at the upper portion of the outer cylinder 1, the inner cylinder 5 is open-ended. The gases flow from the bottom of the outer cylinder 1 into the fluid balls 3 inside of the support plate circular path via the inner cylinder 5, support plate openings 16, and deflectors 15 orderly. Guided by the deflectors 15, the gas flows upwards along the radial direction at a sharp angle so as to push the fluid balls to spin and planetarily move along the circular path between the inner cylinder 5 and the outer cylinder 1. Under the lubrication of the spray liquid from the absorption liquid spray tube 4, a layer of liquid film is formed on the surface of the fluid balls 3 and acts as an absorption layer.

In a one-layer structure, the absorption spray liquid after being processed flows to the bottom of the outer cylinder 1 and is discharged through the absorption liquid discharge outlet 8, while the purified gases are discharged through the gas flow outlet 14 after being dehydrated by the demister plate 6. In a two-layer structure, after being processed by the first layer structure, the absorption liquid spray flows to the bottom of the outer cylinder and is discharged through the absorption liquid discharge outlet 8, while the purified gases flow into the support plate 2 of the second layer structure via the central through hole of the liquid catch tray 12, and then flow into the fluid balls 3 inside of the support plate circular path via the openings 16 and the deflectors 15 on the support plate. Guided by the deflectors 15, the gas flows upwards along the radial direction in sharp angle so as to push the fluid balls to spin and planetarily move along the circular path between the inner cylinder 5 and the outer cylinder 1. Under the lubrication of the spray liquid from the absorption liquid spray tube 4, a layer of liquid film is formed on the surface of the fluid balls 3 and acts as an absorption layer. After being processed by the second layer, the absorption spray liquid flows onto the surface of the frustum cone of the liquid catch tray 12 and then is discharged through the absorption liquid discharge outlet 11, while the purified gases are discharged through the gas flow outlet 14 after being dehydrated by the demister plate 6.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A reflecting packed column, comprising
an outer cylinder (1),
a support plate (2) disposed inside of the outer cylinder,
a plurality of fluid balls (3) disposed on the support plate,
an absorption liquid spray tube (4),
a gas flow inlet (13),
a gas flow outlet (14), and
absorption liquid discharge outlets (11, 8) disposed outside of said outer cylinder (1),
wherein
said support plate (2) is engaged with said outer cylinder (1),
an inner cylinder (5) is connected to the center of the support plate (2), and
a plurality of openings (16) and deflectors (15) connected to the openings are disposed on the circular edge of the inner cylinder.

2. The reflecting packed column of claim 1, wherein the packed material rotates orderly on the circular path of support plate (2) between the inner cylinder (5) and the outer cylinder (1) pushed by the ascending gas flow.

3. The reflecting packed column of claim 1, wherein the inclination angle of said deflector (15) with respect to said support plate (2) is a sharp angle.

4. The reflecting packed column of claim 1, wherein the opening (16) on said support plate (2) is a strip type opening.

5. The reflecting packed column of claim 1, wherein the opening (16) on said support plate (2) is of an irregular shape.

6. The reflecting packed column of claim 1, wherein the openings (16) on said support plate (2) are arranged in a circular array.

7. The reflecting packed column of claim 1, wherein said fluid balls (3) are planetarily arrayed on the circular path on the support plate (2) between the inner cylinder (5) and the outer cylinder (1).

8. The reflecting packed column of claim 1, wherein said absorption liquid spray tube (4) is disposed above the fluid balls (3) and along the circular path of the inner cylinder (5).

9. The reflecting packed column of claim 1, where said support plate (2), said fluid balls (3) on said support plate, and said absorption liquid spray tube (4) form an one-layer structure.

10. The reflecting packed column of claim 1, where said support plate (2), said fluid balls (3) on said support plate, and said absorption liquid spray tube (4) form a two-layer structure.

11. The reflecting packed column of claim 1, where said support plate (2), said fluid balls (3) on said support plate, and said absorption liquid spray tube (4) form a multi-layer structure.

12. The reflecting packed column of claim 9, wherein a liquid catch tray (12) is disposed between the two layers of said two-layer structure, said liquid catch tray (12) is a frustum cone having a central through hole.

13. The reflecting packed column of claim 11, wherein said absorption liquid discharge outlet (11) is disposed at the lower portion of said liquid catch tray (12).

14. The reflecting packed column of claim 1, wherein said absorption liquid discharge outlet (8) is disposed at the lower portion of said outer cylinder (1).
